(19) United States
(12) Patent Application Publication
(10) Pub. No.: US 2015/0261193 A1
(43) Pub. Date: Sep. 17, 2015

(54) LIQUID POWERED WATCH

(71) Applicant: MARK A. BEDOL, Claremont, CA (US)

(72) Inventors: MARK A. BEDOL, CLAREMONT, CA (US); ROBERT D. THOMPSON, BALTIMORE, MD (US)

(73) Assignee: MARK A. BEDOL, Claremont, CA (US)

(21) Appl. No.: 14/208,617

(22) Filed: Mar. 13, 2014

(51) Int. Cl. G04C 10/00

(52) U.S. Cl. CPC G04C 10/00

(57) ABSTRACT

A liquid powered device, including a housing assembly configured to be worn on the wrist of a user. The housing assembly includes a front portion and a back portion. The front portion includes an upper liquid seal member. A liquid tank assembly is secured within the housing assembly. The liquid tank assembly has a fluid inlet. A power assembly is secured within the liquid tank assembly. An electronic module assembly is secured within the upper liquid seal member. The power assembly is in fluid communication with the fluid inlet to provide filling of the power assembly. The power assembly and the electronic module assembly are each separately liquid sealed.

### BACKGROUND OF THE INVENTION

1. Field of the Invention

The present invention relates to portable electrolyte powered devices and more particularly to a liquid powered device that utilizes a power assembly and electronic module assembly that are separately liquid sealed.

2. Description of the Related Art

Electrolyte solutions are known in the prior art for providing power to operate very low power consumption devices such as clocks and calculators. For example, Bedol International Group, Inc., Claremont, Calif., distributes a portable “Water Clock” that is operated by water. The Bedol “Water Clock” includes a cap that extends from an upper portion of the housing of the device.

Present co-inventor Mark A. Bedol is also a co-inventor of the invention disclosed in U.S. Ser. No. 29/313,579, filed on Jan. 23, 2009, entitled “Clock.”

Present co-inventor Mark A. Bedol is also a co-inventor of the invention disclosed in U.S. Ser. No. 12/541,432, filed on Aug. 14, 2009, entitled “LIQUID POWERED ASSEMBLY.”

### SUMMARY OF THE INVENTION

In a broad aspect, the present invention is a liquid powered device, including a housing assembly configured to be worn on the wrist of a user. The housing assembly includes a front portion and a back portion. The front portion includes an upper liquid seal member. A liquid tank assembly is secured within the housing assembly. The liquid tank assembly has a fluid inlet. A power assembly is secured within the liquid tank assembly. An electronic module assembly is secured within the upper liquid seal member. The power assembly is in fluid communication with the fluid inlet to provide filling of the power assembly. The power assembly and the electronic module assembly are each separately liquid sealed.

The present invention enables powering a wrist watch with water. In order for a watch to be usefully worn on a wrist, the electronics and mechanical elements of the watch need to be protected from being shorted from exposure to water. A watch user will in the course of use wash their hands, be exposed to rain or other climate elements, spill liquid by mistake or otherwise get their arms and hands wet. If the inner electronic or working mechanism of a watch is not protected, it will be shorted out from the water exposure. The present invention protects the electronic elements from the potential liquid exposure from the environment. It also protects electronic mechanisms from water exposure from its own power source, the water tank that is providing the power to run the watch. This unique double seal is a key and unique advantage that enables the liquid powered watch to be worn safely on a wrist.

### BRIEF DESCRIPTION OF THE DRAWINGS

FIG. 1 is a perspective view of the liquid powered device of the present invention.

FIG. 2 is a top view of the liquid powered device of FIG. 1.

FIG. 3 is a bottom view of the liquid powered device of FIG. 1.

FIG. 4 is a bottom, side perspective view of the liquid powered device, shown with the wrist strap removed.

FIG. 5 is a top perspective view of the liquid powered device, shown cut away to show the internal components thereof.

FIG. 6 is an exploded bottom perspective view of the liquid powered device.

FIG. 7 is an exploded top perspective view of the liquid powered device.

### DETAILED DESCRIPTION OF THE INVENTION

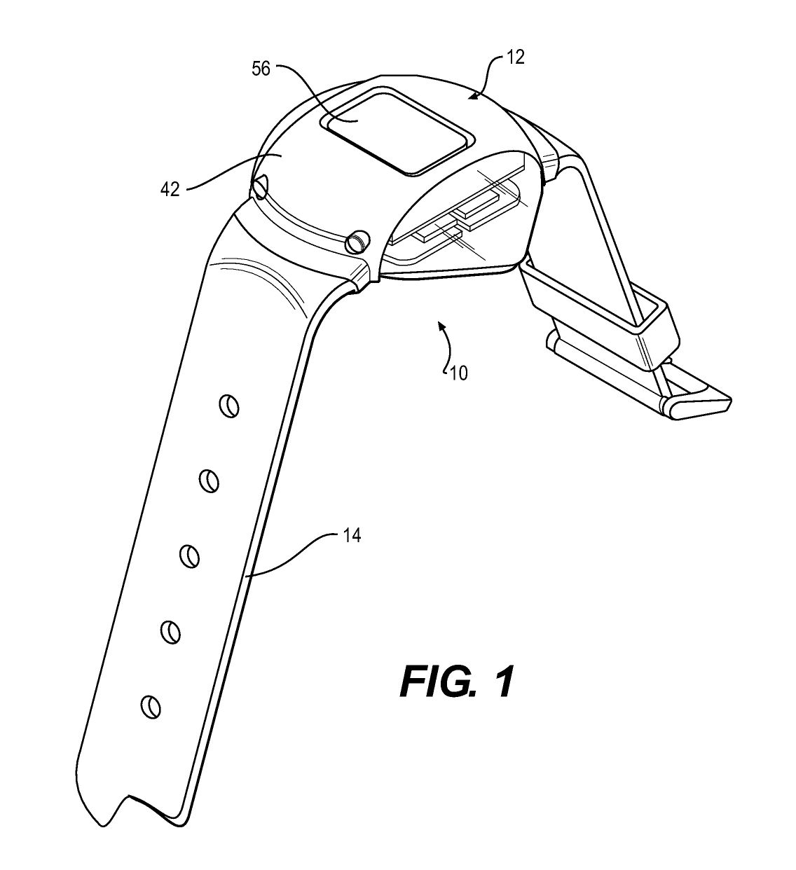

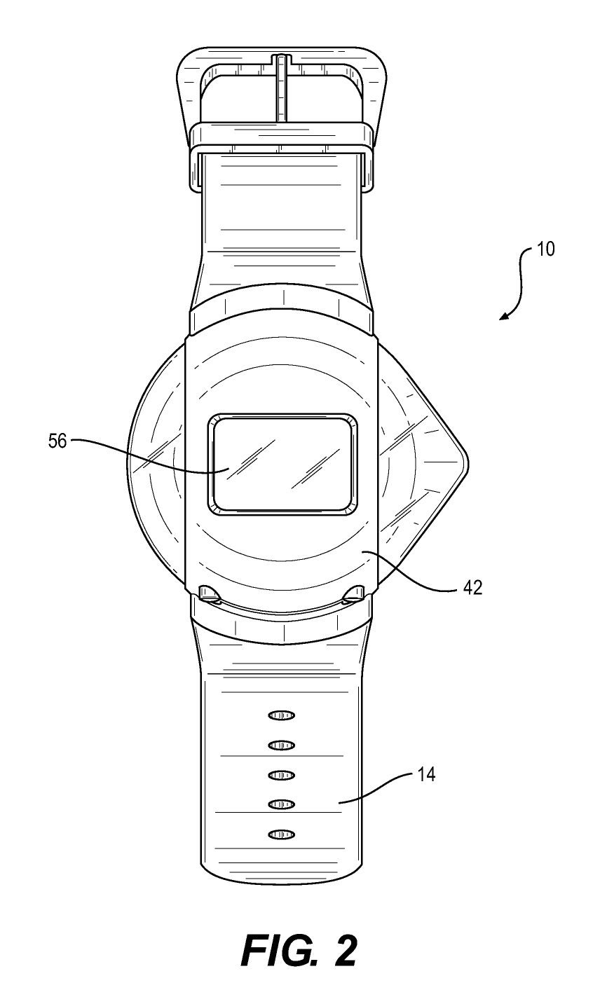

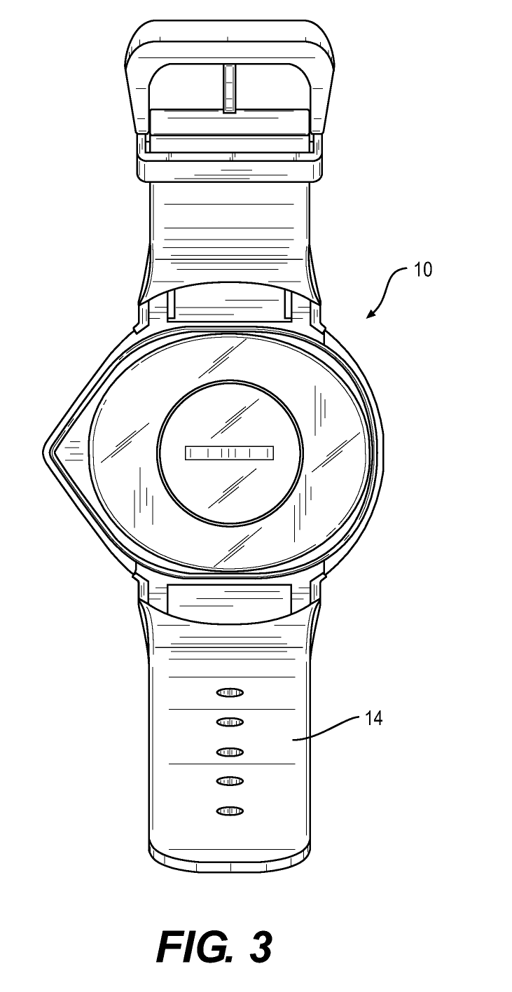

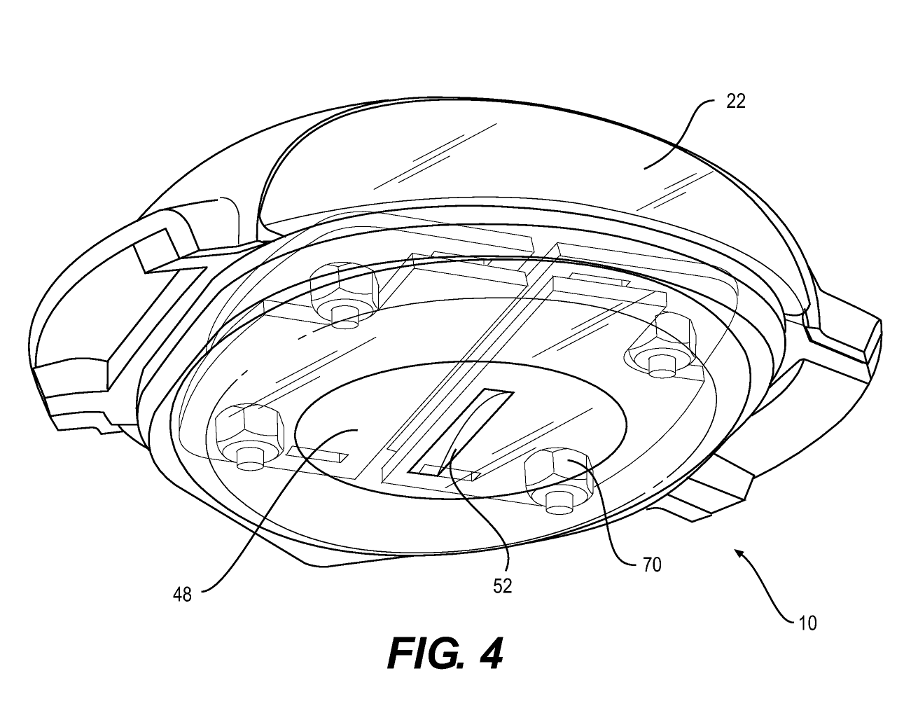

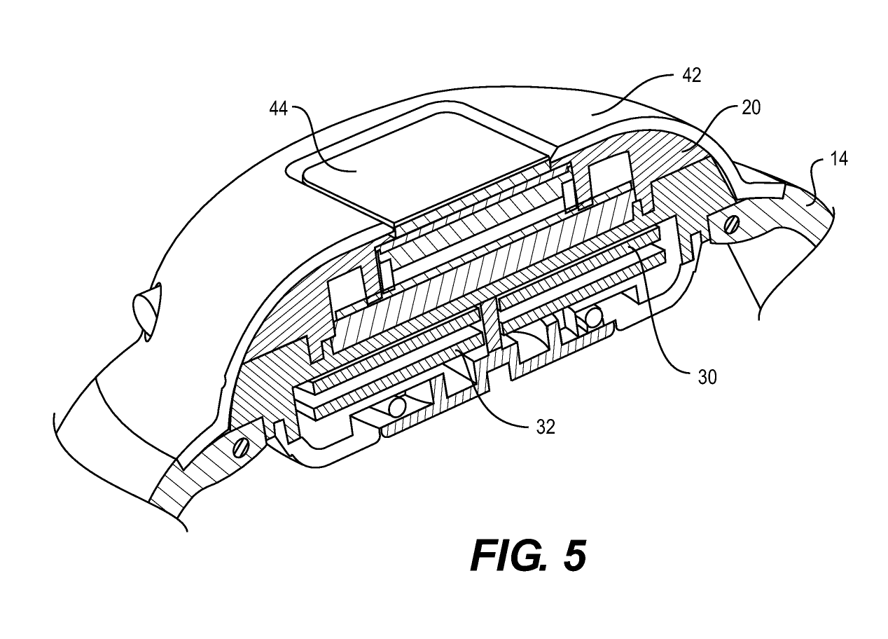

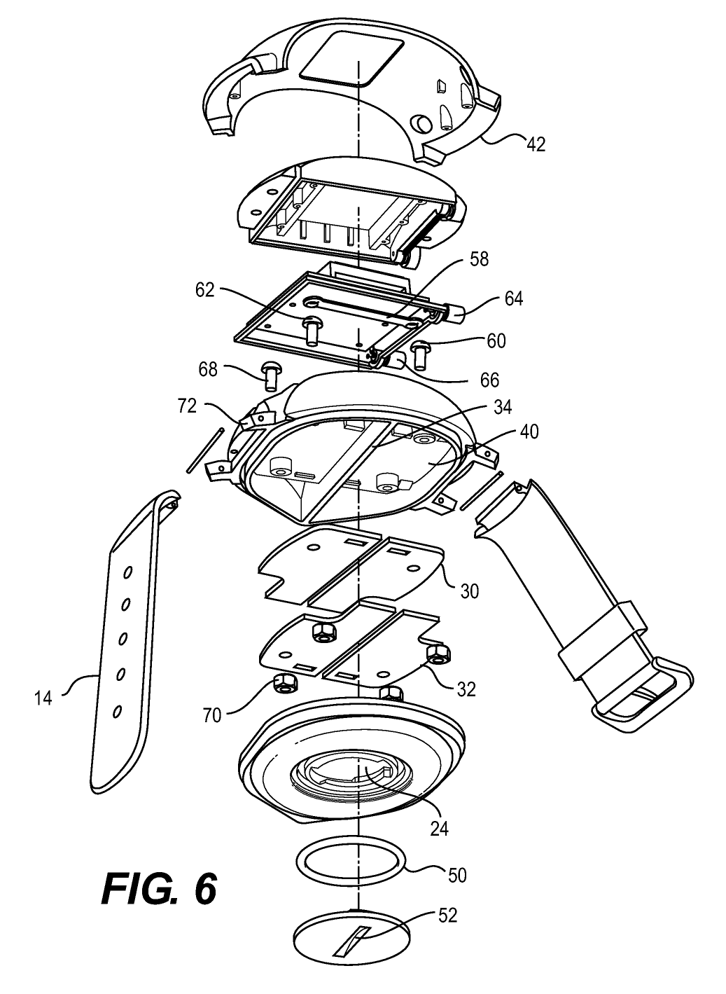

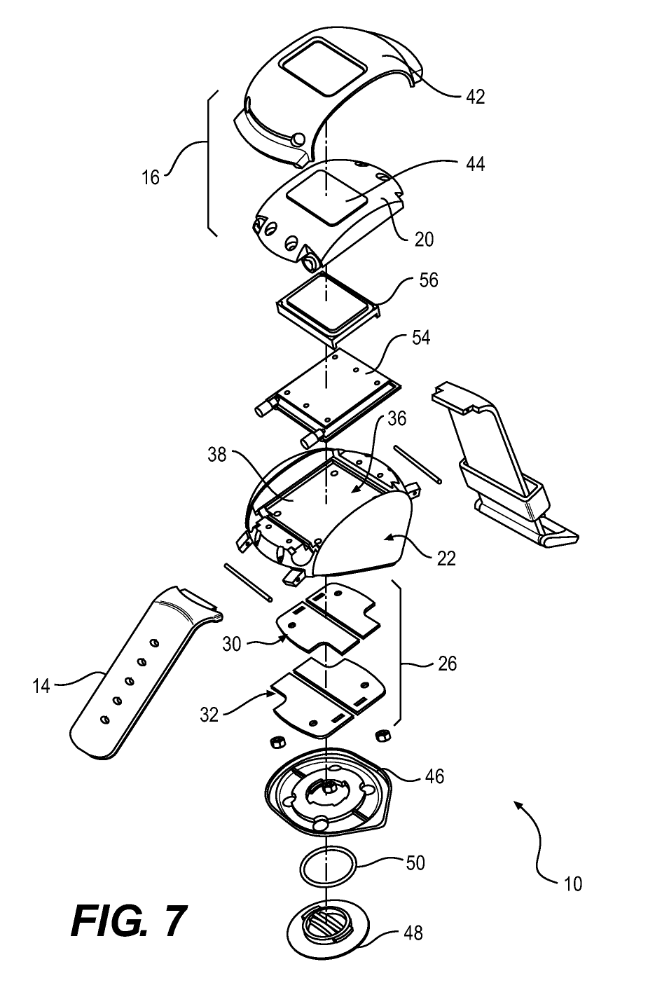

Referring to the drawings and the characters of reference marked thereon, FIGS. 1-7 illustrate the liquid powered device, designated generally as 10. The device 10 includes a housing assembly, designated, generally as 12; that is configured to be worn on the wrist of a user via a wristband 14. The device 10 shown in this figure is embodied as a watch in this preferred embodiment. The housing assembly 12 includes a front portion 16 and a back portion 18. Although the housing assembly 12 is shown in the figures as being clear, it can be clear or transparent. The front portion 16 includes an upper liquid seal member 20. A liquid tank assembly 22 is secured within the housing assembly 12. The liquid tank assembly 22 includes a fluid inlet 24. A power assembly 26 is secured within the liquid tank assembly 22. An electronic module assembly 28 is secured within the liquid tank assembly 22. The power assembly 26 is in fluid communication with the fluid inlet 24 to provide filling of the power assembly 26. The power assembly 26 and the electronic module assembly 28 are each separately liquid sealed.

The power assembly 26 includes two sets of metal elements 30, 32. Each set of metal elements is configured to produce an electrolyte charge. The two sets are divided into separate chambers to total two power cells. In each chamber, each set includes a pair of metallic elements that are polar opposites which react with electrolyte solution to generate an electric charge that can power the electronic module. Typically these elements or plates are formed of copper and zinc. Thus, during operation the device 10 is filled with an electrolyte solution 30 typically water. Thus, electricity is generated as well known by those familiar with liquid batteries.

The liquid tank assembly 22 includes a divider 34 for separating the metal elements of each respective set 30, 32 of metal elements. The upper liquid seal member 20 cooperates with an upper liquid seal portion 36 of the liquid tank assembly 22 to provide a sealing engagement there between.

The upper liquid seal portion 36 includes an upper sealing surface 38 and a lower sealing surface 40. The upper sealing surface 38 cooperates with the upper liquid seal member 20 for sealing the electronic module assembly 28. The lower sealing surface 40 cooperates with the back portion 18 for sealing the power assembly 26.

The manner of sealing is preferably ultrasonic sealing for both sealing the electronic module assembly 28 and sealing the power assembly 26. However, alternatively sealing by glue can be utilized.

The front portion 16 preferably includes a face plate 42 configured to encapsulate the upper liquid seal member 20. The upper liquid seal member 20 preferably includes a transparent viewing window 44.

The back portion 18 of the housing assembly 12 includes a back plate 46 connected to the liquid tank assembly 22, a water cap 48, and a washer 50 positioned between the back plate 46 and the water cap 48. The water cap 48 includes an indentation 52 for turning the water cap 48 for opening and closing the fluid inlet 24. Thus, in this preferred embodiment, the fluid inlet 24 is at the back portion 18 of the housing assembly 12. However, in alternate embodiments, the fluid inlet 24 may be formed at, for example, sidewalls of the liquid tank assembly 22.

The electronic module assembly 28 includes an electronic module element 54 operatively connected to a liquid crystal display (LCD) 56. The electronic module element 54 has a connecting plate 58 operatively connected at a back surface thereof. The power assembly 26 includes a pair of conducting screws 60, 62. Each set of metal elements 30, 32 is configured to produce an electrolyte charge. Each conductive screw 60, 62 of an associated set of metal elements 30, 32 is arranged and positioned to conduct electricity from its associated metal element to the connecting plate 58. The electronic module assembly 28 also includes a plurality of set buttons 64, 66.

Plate attachment screws/nuts 68, 70 attach the metal elements 30, 32 to the liquid tank assembly 22. Engagement elements 72 that extend from the sides of the liquid tank assembly 22 provide attachment of the wrist band 14.

Other embodiments and configurations may be devised without departing from the spirit of the invention and the scope of the appended claims.

1. A liquid powered device, comprising:
a) a housing assembly configured to be worn on a wrist of a user, said housing assembly including a front portion and a back portion, said front portion including an upper liquid seal member;
b) a liquid tank assembly secured within said housing assembly, said liquid tank assembly having a fluid inlet;
c) a power assembly secured within said liquid tank assembly;
d) electronic module assembly secured within said upper liquid seal member;
wherein said power assembly is in fluid communication with said fluid inlet to provide filling of said power assembly,
said power assembly and said electronic module assembly each being separately liquid sealed.

2. The liquid powered device of claim 1, wherein said power assembly comprises two sets of metal elements, each set configured to produce an electrolyte charge.

3. The liquid powered device of claim 2, wherein said liquid tank assembly includes a divider for separating the metal elements of each respective set of metal elements.

4. The liquid powered device of claim 3, wherein said upper liquid seal member cooperates with an upper liquid seal portion of said liquid tank assembly to provide a sealing engagement there between.

5. The liquid powered device of claim 3, wherein an upper liquid seal portion of said liquid tank assembly includes an upper sealing surface and a lower sealing surface, said upper sealing surface cooperating with said upper liquid seal member for sealing said electronic module assembly; and, said lower sealing surface cooperating with said back portion for sealing said power assembly.

6. The liquid powered device of claim 3, wherein an upper liquid seal portion of said liquid tank assembly includes an upper sealing surface and a lower sealing surface, said upper sealing surface cooperating with said upper liquid seal member for ultrasonically sealing said electronic module assembly; and, said lower sealing surface cooperating with said back portion for ultrasonically sealing said power assembly.

7. The liquid powered device of claim 1, wherein said front portion further comprises a face plate encapsulating said upper liquid seal member.

8. The liquid powered device of claim 1, wherein said back portion of said housing assembly includes said fluid inlet.

9. The liquid powered device of claim 1, wherein said back portion of said housing assembly includes a back plate connected to said liquid tank assembly, a water cap, and a washer positioned between said back plate and said water cap.

10. The liquid powered device of claim 1, wherein said liquid tank assembly includes a plurality of engagement elements for securing a wristband.

11. The liquid powered device of claim 1, wherein said upper liquid seal member includes a transparent viewing window.

12. The liquid powered device of claim 1, wherein said electronic module assembly comprises an electronic module element operatively connected to an LCD.

13. The liquid powered device of claim 1, wherein said electronic module assembly comprises an electronic module element operatively connected to an LCD, said electronic module element having a connecting plate operatively connected at a back surface thereof; and wherein said power assembly includes a pair of conducting screws, said power assembly further comprising two sets of metal elements, each set configured to produce an electrolyte charge, wherein each said conductive screw of an associated set of metal elements is arranged and positioned to conduct electricity from its associated metal element to said connecting plate.

14. The liquid powered device of claim 1, wherein said electronic module assembly includes a plurality of set buttons.

15. The liquid powered device of claim 3, wherein said liquid powered device comprises a watch.
